(19) United States
(12) Patent Application Publication
(10) Pub. No.: US 2026/0186993 A1
(43) Pub. Date: Jul. 2, 2026

(54) Device and Method for Synchronized Memory

(71) Applicant: Microchip Technology Inc., Chandler, AZ (US)

(72) Inventor: Ravindra Kumar, Austin, TX (US)

(73) Assignee: Microchip Technology Inc., Chandler, AZ (US)

(21) Appl. No.: 19/373,125

(22) Filed: Oct. 29, 2025

Related U.S. Application Data
(60) Provisional application No. 63/739,069, filed on Dec. 26, 2024.

(51) Int. Cl. G06F 13/24; G06F 9/30

(52) U.S. Cl. CPC G06F 13/24; G06F 9/30043

(57) ABSTRACT

A microcontroller is provided comprising a processor, a data bus interface, a random access memory (RAM) including a plurality of pages, and a non-transitory computer readable memory including instructions, that when executed on the processor, after the microcontroller writes data to a first page of the plurality of pages, send a first interrupt to a host CPU external to the microcontroller; and process a second interrupt triggered by the host CPU, the second interrupt indicating a write by the CPU to the second page of the plurality of pages.

RELATED PATENT APPLICATION

This application claims priority to U.S. Provisional Application No. 63/739,069 filed December 26, 2024, the entire contents of which are hereby incorporated by reference.

### FIELD OF THE INVENTION

This disclosure relates to multiprocessor memory architectures.

### BACKGROUND

Data sharing between two processors can be complex, require specialized hardware, or be limited in flexibility. In one example, sharing data between a processor and an embedded controller has historically been handled through fixed-length messages passed through registers, for example the legacy 8042 / ACPI EC interface.

### SUMMARY

In some examples, a microcontroller is provided comprising a processor; a data bus interface; a random access memory (RAM) including a plurality of pages; and a non-transitory computer readable memory including instructions that when executed on the processor, after the microcontroller writes data to a first page of the plurality of pages, send a first interrupt to a host central processing unit (CPU) external to the microcontroller, the first interrupt identifying the first page; and process a second interrupt triggered by the host CPU, the second interrupt identifying a second page of the plurality of pages and indicating a write by the host CPU to the second page.

In one or more examples in the preceding paragraphs, the first page is exposed to the host CPU as mapped memory to allow instructions executing on the external CPU to access the first page via one or more physical memory addresses.

In one or more examples in the preceding paragraphs, the host CPU and the microcontroller share a common definition of the plurality of pages including a definition of the start and end addresses of each of the plurality of pages.

In one or more examples in the preceding paragraphs, the non-transitory computer readable memory includes instructions that when executed on the processor to process the second interrupt read a register value to determine which of the plurality of pages was modified by the host CPU.

In one or more examples in the preceding paragraphs, the first page is not the same size in bytes as the second page.

In one or more examples in the preceding paragraphs, the first page and second page are not contiguous.

In one or more examples in the preceding paragraphs, the microcontroller comprises a register that, when written to by the host CPU, triggers the second interrupt.

In one or more examples, a system is provided comprising a host central processing unit (CPU); a random access memory (RAM); a data bus interface to read and write data arranged in a plurality of pages of RAM in a microcontroller external to the host CPU, and a non-transitory computer readable memory including instructions that when executed by the host CPU: after the microcontroller writes data to a first page of the plurality of pages, receive a first interrupt at the host CPU, the first interrupt identifying a first page of the plurality of pages and indicating a completed write by the microcontroller to the first page; and after writing data to a second page of the plurality of pages, generate a second interrupt at the microcontroller, the second interrupt identifying the second page.

In one or more examples in the preceding paragraphs, the first page is exposed to the host CPU as mapped memory to allow instructions executing on the host CPU to access the first page via one or more physical memory addresses.

In one or more examples in the preceding paragraphs, the host CPU and the microcontroller share a common definition of the plurality of pages including a definition of the start and end addresses of each of the plurality of pages.

In one or more examples in the preceding paragraphs, the non-transitory computer readable memory includes instructions that when executed on the host CPU to process the first interrupt: read a register value to identify which of the plurality of pages was modified by the microcontroller; and identify a range of physical addresses associated with the identified page.

In one or more examples in the preceding paragraphs, the first page is not the same size in bytes as the second page.

In one or more examples in the preceding paragraphs, the first page and second page are not contiguous.

In one or more examples in the preceding paragraphs, the instructions to generate the second interrupt at the microcontroller include instructions that when executed by the host CPU write a second page identifier to a register on the microcontroller to generate the second interrupt.

In some examples, a method is provided and performed in a microcontroller comprising: a processor; a data bus interface; a random access memory (RAM) including a plurality of pages; and a non-transitory computer readable memory including instructions to be executed by the processor. The method comprises writing data to a first page of the plurality of pages, after writing data to the first page of the plurality of pages, sending a first interrupt to a host CPU external to the microcontroller, the first interrupt identifying the first page; and processing a second interrupt triggered by the host CPU, the second interrupt indicating a write by the host CPU to a second page of the plurality of pages.

In one or more examples in the preceding paragraphs, the first page is exposed to the host CPU as mapped memory to allow instructions executing on the host CPU to access the first page via one or more physical memory addresses.

In one or more examples in the preceding paragraphs, the host CPU and the microcontroller share a common definition of the plurality of pages including a definition of the start and end addresses of each of the plurality of pages.

In one or more examples in the preceding paragraphs, the method comprises, after the second interrupt has been triggered by the host CPU, reading a register value to determine which of the plurality of pages was modified by the host CPU.

In one or more examples in the preceding paragraphs, the first page is not the same size in bytes as the second page.

In one or more examples, the method comprises testing a semaphore before writing to the first page.

### BRIEF DESCRIPTION OF THE FIGURES

FIG. 1 illustrates a microcontroller with shared memory, according to certain examples.

FIG. 2 illustrates a system comprising a microcontroller with shared memory, according to certain examples.

FIG. 3 illustrates another system comprising a microcontroller with shared memory, according to certain examples.

FIG. 4 illustrates a shared page definition, according to certain examples.

FIG. 5 illustrates a method for managing shared memory in a microcontroller, according to certain examples.

### DETAILED DESCRIPTION

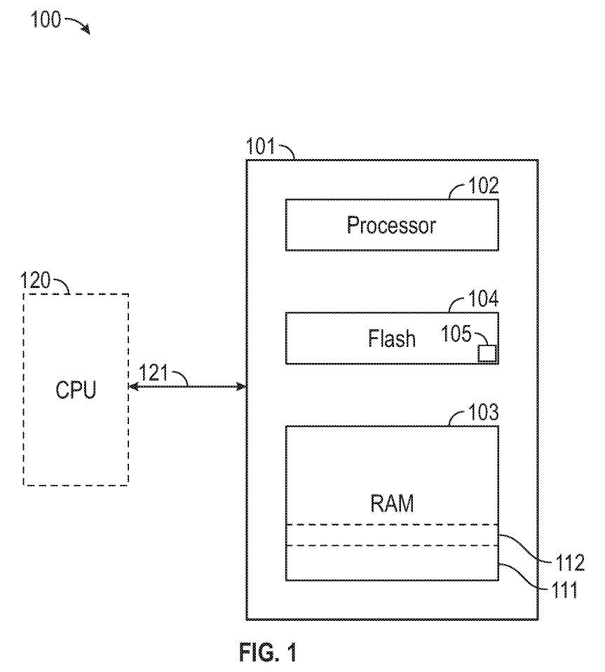

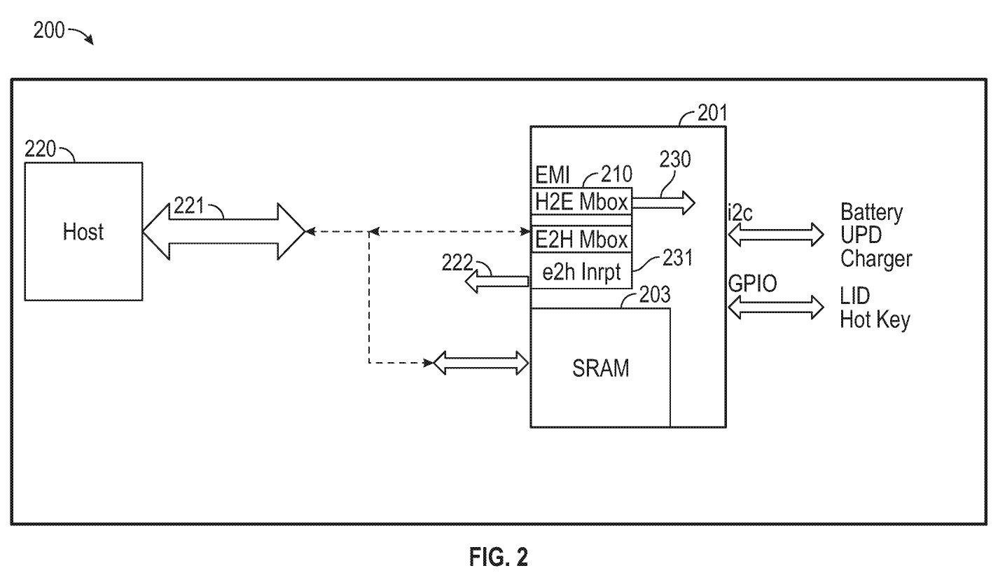

FIG. 1 illustrates a microcontroller with shared memory, according to certain examples. In one example, system 100 may be a personal computer including microcontroller 101 coupled to host CPU 120 via data bus 121. In some examples, data bus 121 may include a protocol for raising an interrupt on host CPU 120. In other examples, a dedicated signal line may allow microcontroller 101 to raise an interrupt on host CPU 120. Data bus 121 may be an eSPI bus in some examples. Microcontroller 101 may be an embedded controller including processor 102, non-transitory computer readable memory 104 and random access memory (RAM) 103. Non-transitory computer readable memory 104 may be flash memory in some examples. Non-transitory computer readable memory 104 may include instructions 105 for sending an interrupt message to host CPU 120 indicating a write to a first page of RAM 103 has been performed by microcontroller 101. Non-transitory computer readable memory 104 may include instructions 105 for processing an incoming interrupt triggered by host CPU 120 indicating a write to a page of RAM 103 has been performed by host CPU 120. For example, microcontroller 101 may include an externally accessible register (such as one of mailbox registers 210 in FIG. 2) associated with trigger logic (such as trigger logic 230). After host CPU 120 writes to a second page in RAM 103, host CPU 120 may write to the externally accessible register the page number associated with the second page. The trigger logic may, in response to the write of the page number associated with the second page, raise an interrupt to processor 102. The interrupt handler portion of instructions 105 may read the page number from the externally accessible register and process a routine for handling a write to the second page.

In some examples, the timing of writes to the first page and the second page may be asynchronous. Writes to the second page may occur, for example, before a write occurs to the first page. In some examples, the first page may be used solely for transferring data from microcontroller 101 to host CPU 120. In some examples, the second page may be used solely for transferring data from host CPU 120 to microcontroller 101. In other examples, a third page may be used for bidirectional communication. In some examples, a memory address may be used as a semaphore to prevent microcontroller 101 and host CPU 120 from concurrently writing data to the third page. In some examples, an application-specific protocol may be employed by microcontroller 101 and host CPU 120 to avoid concurrent writes. For example, host CPU 120 may write to the third page, write the page number associated with the third page to the externally accessible register, and refrain from writing to the third page until it receives an interrupt from microcontroller 101 signaling a write to the third page.

RAM 103 may be configured with a plurality of pages (e.g., pages 111 and 112) of shared memory. Data bus 121 may be configured to allow CPU to read from and write to shared pages 111 and 112 of RAM 103 within microcontroller 101. Pages 111 and 112 may be defined in a configuration or header file and the definition may be known to host CPU 120 and microcontroller 101. Pages 111 and 112 may be different lengths, in some examples, and may be further defined as containing structured data. Either of host CPU 120 and microcontroller 101 can read from RAM 103 at any time without notice to the other. However, if either writes to a page (111 or 112) of shared memory, it needs to interrupt the other and identify the page written to. In some examples, a semaphore may be used to prevent a read/write concurrent with a write cycle. Pages 111 and 112 are not contiguous in some examples. A semaphore is a data structure with hardware support for atomic operations that may be used to prevent concurrent writes or concurrent reads and writes. In some examples, processor may support a wait operation that blocks a thread of execution until the value of the semaphore is greater than zero. The wait operation firsts tests the value of the semaphore, and if it is greater than zero it decrements the semaphore and returns. In some examples, a processor may support a test and set instruction or a compare and swap. In each case, the processor reads the semaphore before proceeding.

In some examples, data bus 121 may support direct read/write access by host CPU 120 to RAM 103. In some examples, host CPU 120 may support mapping memory addresses directly to RAM 103 in a byte-for-byte correlation such that a host CPU 120 write to a physical memory address (e.g., 0xFED75001) will result in a write to a location within RAM 103. These mapped memory locations may be referred to herein as mapped memory or memory mapped storage. In some examples, mapped memory may allow caching reads by host CPU 120 of locations in RAM 103. In these examples, an interrupt processing routine executing on host CPU 120 may notify the memory management system to invalidate any cached copies of data within a page identified by microcontroller 101 as having been written by microcontroller 101.

FIG. 2 illustrates a specific type of microcontroller with shared memory, according to certain examples. System 200 may be a personal computer motherboard with host CPU 220 in communication with embedded controller 201 via enhanced serial peripheral interface (eSPI) bus 221 and system control interrupt (SCI) 222. SCI 222 may be a virtual wire that triggers an interrupt at host CPU 220. This virtual wire may be a message type, a signaling protocol, or other mechanism. Host CPU 220 may use an eSPI peripheral memory cycle to read from or write to shared pages in SRAM 203. In some examples, embedded controller 201 may use SRAM base address register (BAR) programming to facilitate direct memory access by host CPU 220. Embedded controller 201 may perform various tasks such as receiving and processing signals from human interface devices like a keyboard, mouse button, or a touchpad. Embedded controller 201 may receive and process signals from buttons (e.g., a power button) or switches (e.g., a hall sensor indicating whether the laptop lid is open or closed). Embedded controller 201 may monitor power (e.g., a power supply and/or a battery), thermal limits, network events (e.g., wake on LAN and/or remote diagnostics and remediation), and other events. Embedded controller 201 may generate an interrupt on SCI 222 to inform a driver (e.g., an advanced configuration and power interface, or ACPI) on host CPU 220 of events relating to the embedded controller functions. eSPI bus 221 was developed to overcome limitations of prior low speed chipset busses, such as the low pin count bus, system peripheral interface bus, and system management bus. Some examples may use one of these prior bus technologies. Embedded controller 201 may include static RAM (SRAM) 203 and a page definition table correlating page numbers to address ranges within SRAM 203. The page definition table may be stored in SRAM 203.

In some examples, embedded controller 201 may include mailbox registers 210 for communicating status information between host CPU 220 and embedded controller 220. In an example, host CPU 220 may write data to page 3 of SRAM 203 with a goal of writing that data to the embedded flash device on the motherboard. After writing to page 3, host CPU 220 may write the number “3” to a host to embedded controller (H2E) mailbox register to trigger an interrupt within microcontroller 201. In some examples, host CPU 220 may write a “1” to the third bit of the H2E mailbox. In some examples, host CPU 220 may write the start address of page 3 to the H2E mailbox. The write to the H2E mailbox trigger logic 230 initiates an interrupt routine within embedded controller 201. As part of the interrupt routine, embedded controller 201 will read the value of the H2E mailbox, determine that page 3 contains new data, and execute a routine to write the data from page 3 to the embedded flash device. In some examples, embedded controller 201 may read the data from the embedded flash device, calculate a hash value, and write the hash value to page 3. In some examples, embedded controller 201, as part of the interrupt handling routine, may write to the E2H mailbox a value identifying page three to notify host CPU 220 that the data written to page 3 was successfully written to the embedded flash device. Logic 231 within embedded controller 201 (e.g., the “e2h interrupt” logic) may the raise an interrupt via SCI 222. In some examples, an interrupt handler executing on host CPU 220 may read the page number (e.g., “3”) from the interrupt message. In some examples, an interrupt handler executing on host CPU 220 may read the page number from E2H Mbox.

In some examples, embedded controller 201 may read battery status data via an i2c interface and may update values in page 2 of SRAM 203. Embedded controller 201 may then write a “2”, in some examples, to an embedded controller to host (E2H) mailbox and trigger an SCI 222 interrupt via eSPI bus 221. In some examples, embedded controller 201 may write a “1” to the second bit of the E2H mailbox. Host CPU 220 will initiate an interrupt handler that will read the value of the E2H mailbox and execute a routine that reads the battery status from page 2 of SRAM 203. In some examples, embedded controller 201 may write the first address of page 2 to the E2H mailbox.

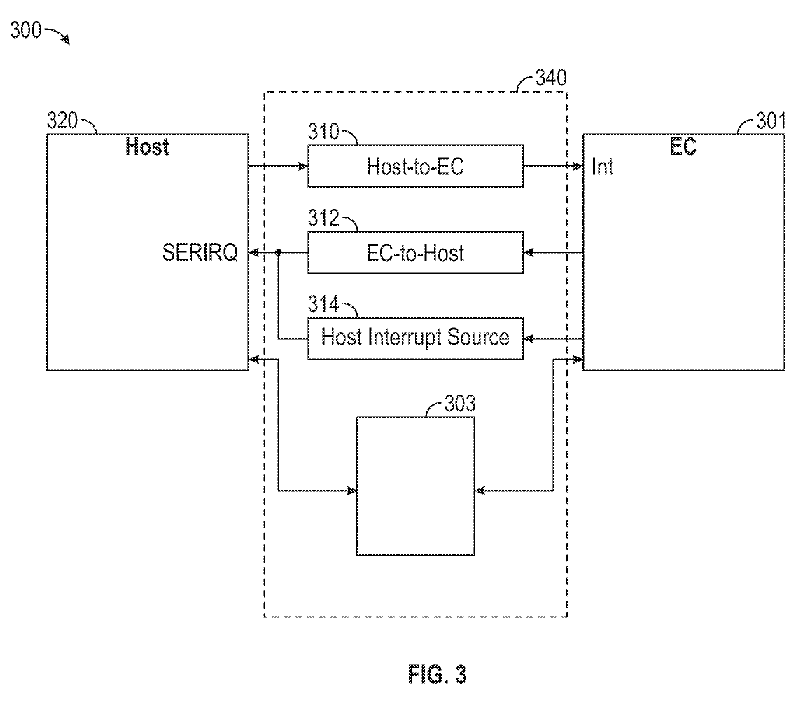

FIG. 3 illustrates a microcontroller with shared memory, according to certain examples. System 300 includes embedded controller (EC) 301 in communication with host CPU 320 is performed via embedded memory interface (EMI) 340 comprising Host-to-EC mailbox 310, EC-to-Host mailbox 312, host interrupt source 314, and shared RAM 303. In some examples, after host CPU 320 writes to shared page 3 (within RAM 303), host CPU 320 writes a representation of the page number, e.g., 3, to Host-to-EC mailbox 310. The write to Host-to-EC mailbox 310 causes EMI 340 to raise an interrupt on EC 301. EC 301 will then execute an interrupt handler to read the page number from Host-to-EC mailbox 310 and execute a page-specific handler routine. For example, the page-specific handler routine may write the contents of page 3 to an embedded flash memory. In some examples, after EC 301 writes to shared page 2 of RAM 303, EC 301 may write a representation of the page number, e.g., 2, to EC-to-Host mailbox 312 and may raise an interrupt via host interrupt source 314. EMI 340 may encode the source of the interrupt, e.g., EC 301, and the page number, e.g., 2, in a serial interrupt request (SERIRQ) to host CPU 320. In some examples, a table of shared page definitions may be maintained in RAM 303. In some examples, EMI 340 may be unaware of shared page definitions.

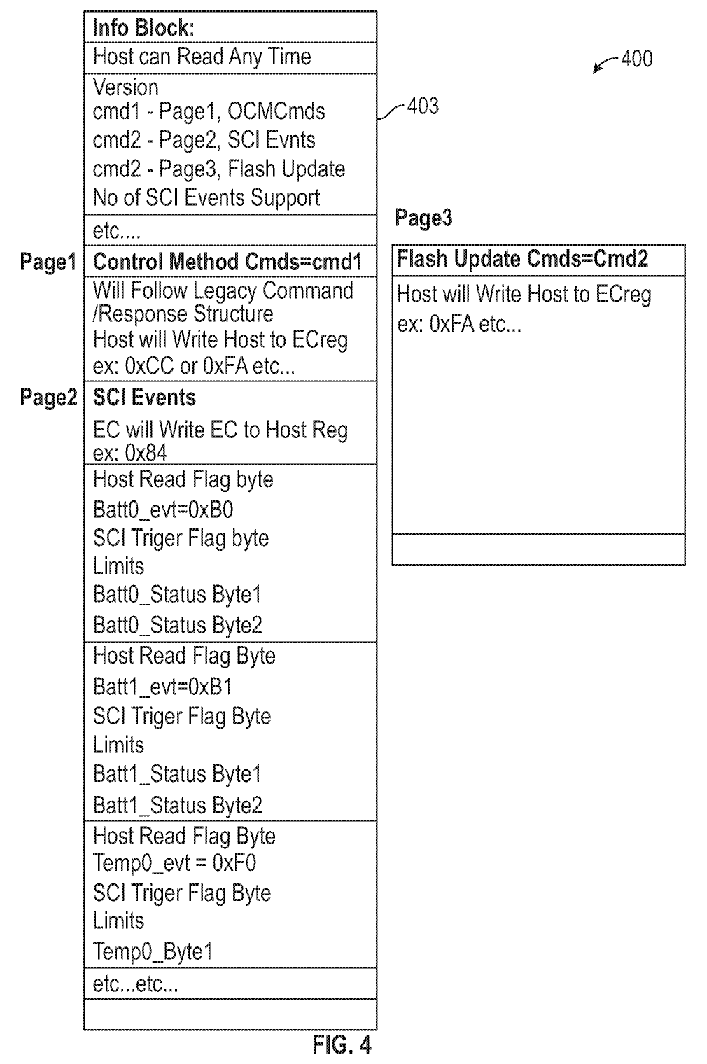

FIG. 4 illustrates a shared page definition according to certain examples. Shared page definition 400 may define the start and end address of each of four pages: page 0, page 1, page 2, and page 3. In some examples, each shared page may read by both host CPU 120 and embedded controller 101. In some examples, some shared pages may only be read by host CPU 120. In some examples, shared pages may be contiguous in memory. In some examples, shared pages may be interspersed with non-shared regions of RAM 103. In some examples, shared page definition 400 may specify command and data fields within a page. In some examples, shared page definition 400 may include, for one or more page definitions, an address of an interrupt handling routine for processing writes to that page. In some examples, page definitions may be of different sizes in bytes. For example, one page may store control commands, which may only require a few. In another example, another page may be at least as large as a flash memory block, which may be 128 bytes, 4K bytes, or 16K bytes in some examples.

Page 0 – In some examples, Page 0 starts at address 0x10, is updated by microcontroller 101, and is read by host CPU 120. Page 0 may enumerate available commands, page information, and events supported. In some examples, Page 0 includes a version identifier that may be checked by the host CPU before proceeding to ensure a common understanding of the page definitions. In some examples, Page 0 identifies three additional pages (Page 1, Page 2, and Page 3) and defines the number of SCI events supported.

Page 1 – In some examples, Page 1 starts at address 0xCC, is updated by host CPU 120 to issue a command, and is read by microcontroller 101 execute that command. host CPU 120 may write a command and argument data to Page 1. In some examples, host CPU 120 may write the address, e.g., 0xCC, to the H2E mailbox register to inform microcontroller 101 of the command in Page 1. Microcontroller 101 may read the command and any arguments from Page 1, execute the command, and write any results to Page 1. Microcontroller 101 may then write the address, e.g., 0xCC, to the E2H mailbox register to signal completion of the command. In some examples, microcontroller 101 may write the return value at the end of Page 1 and may write the address of the return value to the E2H mailbox register. In some examples, microcontroller 101 may write the return value to the beginning of Page 1 and may write the address of the return value to the E2H mailbox register, e.g., 0xCC.

Page 2 – In some examples, Page 2 starts at address 0x84, is updated by microcontroller 101, and is read by host CPU 120. Page 2 may include a predetermined number of event records (e.g., the number specified in Page 0). Each SCI event record may include a HostRead flag that may be reset by microcontroller 101 when new data has been written and set by host CPU 120 when that data has been read. In some examples, each SCI event record may include an event code (e.g., 0xB0 for an event on Battery 0), a trigger flag byte, limits, and two status bytes.

Page 3 – In some examples, Page 3 starts at address 0xFA, is updated by host CPU 120, and is read by microcontroller 101. host CPU 120 may write one or more flash update commands to Page 3 and then write 0xFA to the H2E mailbox register. In response, microcontroller 101 may read and execute the command or commands from Page 3.

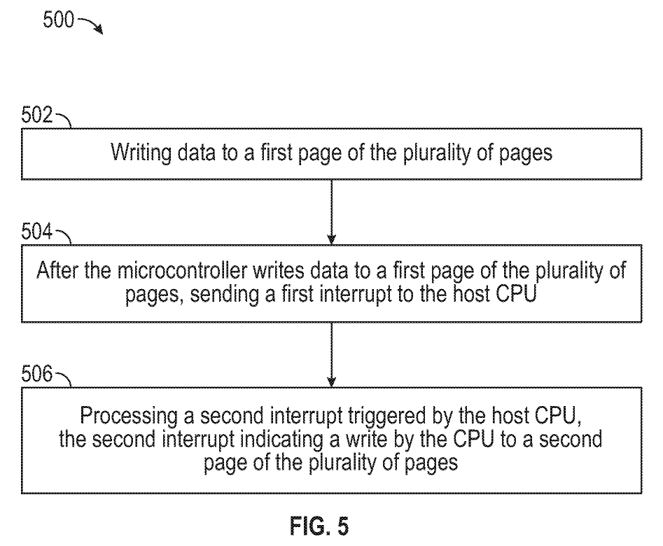

FIG. 5 illustrates a method for managing shared memory in a microcontroller, according to certain examples. Method 500 begins at block 502. At block 502, the microcontroller writes data to a first of a plurality of pages. At block 504, which occurs after the write in block 502, the microcontroller sends a first interrupt to the host CPU. In some examples, the code writing to the first of the plurality of pages writes the page number of the modified page to a mailbox register that triggers generation of the first interrupt. At block 506, the microcontroller processes a second interrupt triggered by the host CPU, the second interrupt indicating a write by the CPU to a second page of the plurality of pages. In some examples, the CPU triggers the second interrupt by writing the number of the second page to a mailbox register that triggers an interrupt in the microcontroller.

Although examples have been described above, other variations and examples may be made from this disclosure without departing from the spirit and scope of these examples.

We claim:

1. A microcontroller comprising:
a processor;
a data bus interface;
a random access memory (RAM) including a plurality of pages; and
a non-transitory computer readable memory including instructions that when executed on the processor:
after the microcontroller writes data to a first page of the plurality of pages, send a first interrupt to a host central processing unit (CPU) external to the microcontroller, the first interrupt identifying the first page; and
process a second interrupt triggered by the host CPU, the second interrupt identifying a second page of the plurality of pages and indicating a write by the host CPU to the second page via the data bus interface.

2. The microcontroller of claim 1, wherein the first page is exposed to the host CPU as mapped memory to allow instructions executing on the host CPU to access the first page via one or more physical memory addresses.

3. The microcontroller of claim 1, wherein the host CPU and the microcontroller share a common definition of the plurality of pages including a definition of the start and end addresses of each of the plurality of pages.

4. The microcontroller of claim 3, the non-transitory computer readable memory including instructions that, when executed on the processor, process the second interrupt to read a register value to determine which of the plurality of pages was modified by the host CPU.

5. The microcontroller of claim 1, wherein the first page is not the same size in bytes as the second page.

6. The microcontroller of claim 1, wherein the first page and second page are not contiguous.

7. The microcontroller of claim 1, comprising a register that, when written to by the host CPU, triggers the second interrupt.

8. A system comprising:
a host central processing unit (CPU);
a random access memory (RAM);
a data bus interface to read and write data arranged in a plurality of pages of RAM in a microcontroller external to the host CPU, and
a non-transitory computer readable memory including instructions that when executed by the host CPU:
after the microcontroller writes data to a first page of the plurality of pages, receive a first interrupt at the host CPU, the first interrupt identifying a first page of the plurality of pages and indicating a completed write by the microcontroller to the first page; and
after writing data to a second page of the plurality of pages, generate a second interrupt at the microcontroller, the second interrupt identifying the second page.

9. The system of claim 8, wherein the first page is exposed to the host CPU as mapped memory to allow instructions executing on the host CPU to access the first page via one or more physical memory addresses.

10. The system of claim 8, wherein the host CPU and the microcontroller share a common definition of the plurality of pages including a definition of the start and end addresses of each of the plurality of pages.

11. The system of claim 10, the non-transitory computer readable memory including instructions that when executed on the host CPU to process the first interrupt:
read a register value to identify which of the plurality of pages was modified by the microcontroller; and
identify a range of physical addresses associated with the identified page.

12. The system of claim 8, wherein the first page is not the same size in bytes as the second page.

13. The system of claim 8, wherein the first page and second page are not contiguous.

14. The system of claim 8, wherein the instructions to generate the second interrupt at the microcontroller include instructions that when executed by the host CPU write a second page identifier to a register on the microcontroller to generate the second interrupt.

15. A method, performed in a microcontroller comprising:
a processor;
a data bus interface;
a random access memory (RAM) including a plurality of pages; and
a non-transitory computer readable memory including instructions to be executed by the processor,
the method comprising:
writing data to a first page of the plurality of pages,
after writing data to the first page of the plurality of pages, sending a first interrupt to a host CPU external to the microcontroller, the first interrupt identifying the first page; and
processing a second interrupt triggered by the host CPU, the second interrupt indicating a write by the host CPU to a second page of the plurality of pages.

16. The method of claim 15, wherein the first page is exposed to the host CPU as mapped memory to allow instructions executing on the host CPU to access the first page via one or more physical memory addresses.

17. The method of claim 15, wherein the host CPU and the microcontroller share a common definition of the plurality of pages including a definition of the start and end addresses of each of the plurality of pages.

18. The method of claim 17, comprising:
after the second interrupt has been triggered by the host CPU, reading a register value to determine which of the plurality of pages was modified by the host CPU.

19. The method of claim 15, wherein the first page is not the same size in bytes as the second page.

20. The method of claim 15, testing a semaphore before writing to the first page.
